(19) United States
(12) Patent Application Publication
(10) Pub. No.: US 2014/0059114 A1
(43) Pub. Date: Feb. 27, 2014

(54) APPLICATION SERVICE PROVIDING SYSTEM AND METHOD AND SERVER APPARATUS AND CLIENT APPARATUS FOR APPLICATION SERVICE

(71) Applicant: Electronics and Telecommunications Research Institute, Daejeon (KR)

(72) Inventors: Won Young KIM, Daejeon (KR); Won Hyuk Choi, Daejeon (KR); Su Min Jang, Daejeon (KR)

(73) Assignee: Electronics and Telecommunications Research Institute, Daejeon (KR)

(21) Appl. No.: 13/900,674

(22) Filed: May 23, 2013

(30) Foreign Application Priority Data
Aug. 27, 2012 (KR) 10-2012-0093703

(51) Int. Cl. H04L 29/06

(52) U.S. Cl. CPC H04L 67/42
USPC 709/203

(57) ABSTRACT

Disclosed is an application service providing system, including: An application service providing system, including: a server apparatus that generates information for a screen output of application programs as virtual rendering objects and sends commands using the virtual rendering objects as parameters to a client apparatus; and a client apparatus that receives the commands, generates actual rendering objects corresponding to the virtual rendering objects, and uses the actual rendering objects to execute the commands.

### CROSS-REFERENCE TO RELATED APPLICATIONS

This application claims priority to and the benefit of Korean Patent Application No. 10-2012-0093703 filed in the Korean Intellectual Property Office on Aug. 27, 2012, the entire contents of which are incorporated herein by reference.

### TECHNICAL FIELD

The present invention relates to a technology of providing an application service under the server based computing environment, and more particularly, to application service providing system and method in which a server executes application programs except the graphic rendering which is done by the clients, and a server apparatus and a client apparatus for an application service.

### BACKGROUND ART

Recently, with the development of a hardware manufacturing technology such as a central processing unit (CPU), a memory, and the like, cheap but powerful computers have been delivered rapidly and software of a desktop computer has been required to accommodate more splendid user interfaces and graphic intensive tasks. A graphics processing unit (GPU) processing is required to the existing graphic intensive applications including 2D/3D or a multimedia and is extensively required to web browser renderings, flashes, and window operation systems.

Meanwhile, the server-based computing can solve the problems such as data security and purchase/management costs of computers in a personal computer-based computing environment. The server-based computing solutions are Citrix's XenDesktop, VMWare's VDI, Microsoft's terminal services based on remote desktop protocol (RDP), and the like.

However, in such server-based computing, the load of the server grows as the number of clients increase since the server executes the whole applications and the client computers serve as terminals only. Moreover, the server based computing has a limitation in performing high-performance graphic rendering applications since vast amount of result screens rendered by the server has to be transmitted to the client computers. Accordingly, the client computers left idling, and service limitations may be brought from server load. Also, this leads to the problems of huge cost for buying the server and slow service performance.

### SUMMARY OF THE INVENTION

The present invention has been made in an effort to provide an application service providing system and method in which a server executes application programs except the graphic rendering which is done by the clients.

Further, the present invention has been made in an effort to provide a server apparatus and a client apparatus in which a server executes application programs except the graphic rendering which is done by the clients.

Generally, an output screen of application programs consists of 3D, 2D and basic window images. Therefore, the application service providing system needs to support not only 3D rendering but also 2D and window rendering.

Generally, the desktop environment of an operating system is exclusively used by one user for any operation time and therefore, the desktop environment of the server is not designed so that two or more users execute different application programs simultaneously. When two users request to execute two application programs in a desktop environment of a server, a side effect that the execution of the application program of one user affects the execution of the application program of the other user may occurs. For example, in the server, an application executed in a foreground window has higher priority than other application executed in a background window, or operations such as focus gain/lost, draw/redraw, minimize/maximize, hide/restore, and the like, on a window screen of an application affect the window screens of the other application executed on the same server. Therefore, virtualization of window management system is needed so that multiusers can execute applications simultaneously and independently in one server in the application service providing system.

An exemplary embodiment of the present invention provides an application service providing system, including: a server apparatus that manages information for screen output of application program as virtual rendering objects and sends rendering commands using the virtual rendering objects as parameters to a client apparatus; and a client apparatus that receives the commands, inquires actual rendering objects corresponding to the virtual rendering objects, and uses the actual rendering objects to execute the commands.

The command may include 2D or 3D rendering command.

The command may include window rendering command.

Another exemplary embodiment of the present invention provides a server apparatus for an application service, including: a virtual rendering object management unit that manages information for rendering of application program as virtual rendering objects and generates rendering commands using the virtual rendering objects as parameters; and a data sending and receiving unit that sends the commands to a client apparatus.

The virtual rendering object management unit manages rendering objects related to 3D, 2D and window rendering commands virtually so that it manages the corresponding window objects independently from the window manager of the operating system of the server.

Yet another exemplary embodiment of the present invention provides a client apparatus for an application service, including: a data sending and receiving unit that receives rendering commands of application program using virtual rendering objects as parameters; and a command processing unit that manages actual rendering objects corresponding to the virtual rendering objects and executes the commands on the actual rendering objects.

Still another exemplary embodiment of the present invention provides a method for providing an application service, including: calling, by application programs driven by a server, graphic rendering related API; generating rendering objects required in the graphic rendering related API as virtual rendering objects; and sending rendering commands using the generated virtual rendering objects as parameters to a client.

The method for providing an application service may further include: receiving, by the client, the command; and inquiring actual rendering objects corresponding to the virtual rendering objects to execute the commands.

The application service providing method may include processing a callback function for performing the actual rendering related command by the server rather than by the client while the client executes the rendering. The method for providing an application service for processing the callback function may further include: calling, by the client, a virtual callback function; sending the command corresponding to the virtual callback function to the server; and calling, by the server, an actual callback function corresponding to the virtual callback function to execute the command.

As set forth above, according to the exemplary embodiments of the present invention, it is possible to provide the graphical application services to a large number of clients with the fast performance above the physical limitation of one server, by enabling the clients to do the graphic rendering.

The present invention virtualizes the window management of serviced applications by enabling the window management system of the clients to manages the windows of the applications without the server directly manages the windows of the applications, that is, the server manages the window management information of application programs as virtual rendering objects and the clients physically manage the window management information of application programs, such that the users can concurrently execute multiple applications independently, exceeding the limitation of the window manager of the server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram of an application service providing system according to an exemplary embodiment of the present invention.

FIG. 2 is a conceptual diagram illustrating a method of enabling a server apparatus and a client apparatus to process commands in an application service providing system according to an exemplary embodiment of the present invention.

FIG. 3 is a flow chart of an application service providing method according to an exemplary embodiment of the present invention.

FIG. 4 is a conceptual diagram illustrating another example of the method of enabling a server apparatus and a client apparatus to process commands in the application service providing system according to the exemplary embodiment of the present invention.

FIG. 5 is a flow chart illustrating a process of processing a call back function among the application service providing methods illustrated in FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described with reference to the accompanying drawings. Hereinafter, substantially same components are each denoted by like reference numerals in the following description and the accompanying drawings and therefore, a repeated description thereof will be omitted. When it is determined that the detailed description of the known art related to the present invention may obscure the gist of the present invention, the detailed description thereof will be omitted.

Various advantages and features of the present invention and methods accomplishing thereof will become apparent from the following description of embodiments with reference to the accompanying drawings. However, the present invention may be modified in many different forms and it should not be limited to the embodiments set forth herein. These embodiments may be provided so that this disclosure will be thorough and complete, and will fully convey the scope of the invention to those skilled in the art and the present invention is defined by the scope of claims. Like reference numerals throughout the description denote like elements.

When it is determined that the detailed description of the known art related to the present invention may obscure the gist of the present invention, the detailed description thereof will be omitted. The following terminologies are defined in consideration of the functions in the present invention and may be construed in different ways by the intention of users and operators. Therefore, the definitions thereof should be construed based on the contents throughout the specification.

Combinations of each block of the appended block diagram and each step of a flow chart may also be executed by computer program instructions. The computer program instructions may be installed in a general purpose computer, a special computer, or processors for other programmable data processing equipments and therefore, the instructions that are executed by a computer or processors for other programmable data processing equipments generate units that perform functions described in each block of a block diagram or each step of a flow chart. These computer program instructions can be stored in a computer usable memory or a computer readable memory that may orient a computer or other programmable data processing equipments so as to implement functions based on a specific method and therefore, the instructions stored in the computer usable or computer readable memory can produce manufacturing items including the instruction unit that performs functions described in each block of a block diagram or each step of a flow chart. The computer program instructions can be installed in a computer or other programmable data processing equipments and thus, a series of operation steps are executed on the computer or other programmable data processing equipments to generate processes executed with a computer, such that instructions executing the computer or other programmable data processing equipments can provide steps for performing functions described in each block of a block diagram and each step of a flow chart.

Each block or each step may indicate a part of a module, a segment, or a code that includes at least one executable instruction for executing specified logical function (s). Alternatively, it is to be noted that in several alternative embodiments, functions mentioned in blocks or steps may be generated, deviating from a sequence. For example, two blocks or steps that are illustrated in succession can be substantially performed simultaneously or the blocks or the steps can sometimes be performed in a reverse order according to the corresponding function.

According to the exemplary embodiment of the present invention, a server manages information for a screen output for application programs using virtual rendering objects and clients manage the information for the screen output for application programs using actual rendering objects corresponding to the virtual rendering objects so that the related graphic rendering is done by the clients, not the server. According to the exemplary embodiment of the present invention, when the server sends rendering commands to the clients, the server sends the rendering commands using the virtual rendering objects managed by the server as parameters to the clients. According to the exemplary embodiment of the present invention, when processing is required in the server while a client processes the rendering commands, a virtual callback function is called from the client and when the client sends the function to the server, the server executes the actual callback function corresponding to the function.

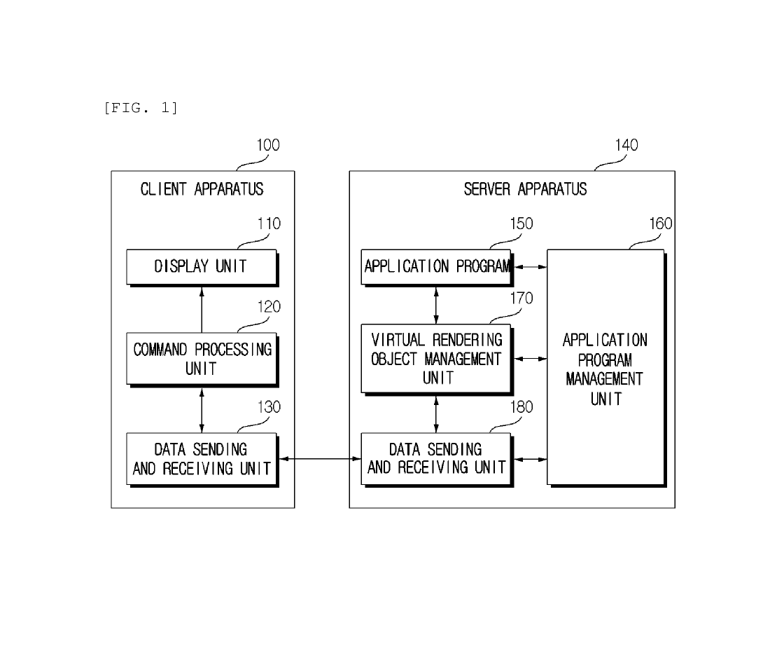

FIG. 1 is a block diagram of an application service providing system according to an exemplary embodiment of the present invention. The application service providing system according to the exemplary embodiment of the present invention is configured to include a client apparatus 100 and a server apparatus 140, wherein the client apparatus 100 and the server apparatus 140 are connected with each other through a wired or wireless communication network. In the exemplary embodiment, one client apparatus 100 is illustrated for convenience, but the server apparatus 140 and the plurality of client apparatuses 100 may be connected with each other through a wired or wireless communication network.

In the exemplary embodiment of the present invention, the server apparatus 140 serves to perform a process of application programs and the client apparatus 100 serves as at least a part (for example, 2D, 3D, or window rendering) of calculations for a screen output of application programs and an actual screen output. As such, in order for the client apparatus 140 separated from the server apparatus 140 to perform the calculations for the screen output of application programs operated by the server apparatus 140, various types of information associated with the screen output of the application programs need to be managed by both of the server apparatus 140 and the client apparatus 100. The information for the screen output of application programs may include window information, user interface control information such as a button, a menu, a list box, a tri control, and the like, device context information, OLE/COM object information, bitmap information, icon information, information on a memory area, and the like. According to the exemplary embodiment of the present invention, the server apparatus 140 manages the information using the virtual rendering objects and the client apparatus 100 manages the information using the actual rendering objects corresponding to the virtual rendering objects managed by the server apparatus 140. When the server apparatus 140 executes the application programs, the virtual rendering objects managed by the server apparatus 140 are used as in-out parameters of an application programming interface (API) to enable the process of application programs to perform operations normally and the client apparatus 100 uses the actual rendering objects corresponding to the virtual rendering objects of the server 140 as the in-out parameters of the API to perform the calculations for the screen output such as the 2D or 3D rendering and perform the actual screen output.

Referring to FIG. 1, the server apparatus 140 includes at least one application program 150, an application program management unit 160, a virtual rendering object management unit 160, and a data sending and receiving unit 180. The client apparatus 100 includes a display unit 110, a command processing unit 120, and a data sending and receiving unit 130.

The application program management unit 160 of the server apparatus 140 manages the execution and finishing of the application program 150 and executes or finishes the application program 150 according to the execution request of the application program or the finishing request of the application program from the client apparatus 100.

The virtual rendering object management unit 170 of the server apparatus 140 manages the information for the screen output of the application program 150 using the virtual rendering objects during the execution of the application program 150. For example, if the information for the screen output corresponds to the window information, the virtual rendering object management unit 170 generates a virtual window object. The generated virtual rendering objects are loaded on the memory that is included in the server apparatus 140. The virtual rendering object management unit 170 may inquire the previously generated virtual rendering objects in the memory, if necessary. The virtual rendering object management unit 170 generates commands using the generated or inquired virtual rendering objects as parameters, as commands that are to be sent to the client apparatus 100. The commands may include a 2D rendering command, a 3D rendering command, or a window rendering command.

The data sending and receiving unit 180 of the server apparatus 140 sends the commands using the virtual rendering objects generated or inquired by the virtual rendering object management unit 170 as parameters to the client apparatus 100.

The data sending and receiving unit 130 of the client apparatus 100 receives the commands using the virtual rendering objects as parameters from the server apparatus 140.

The command processing unit 120 of the client apparatus 100 inquires the actual rendering objects corresponding to the virtual rendering objects included in the commands received from the server apparatus 140 and executes the corresponding commands for the actual rendering objects. For example, when the virtual rendering objects correspond to the virtual window objects, the command processing unit 120 inquires the actual window objects corresponding to the virtual window objects. The actual rendering objects are loaded on the memory that is included in the client apparatus 100. The command processing unit 120 performs rendering operations for the actual rendering objects when the commands received from the server apparatus 140 correspond to the rendering commands. When a new actual rendering object is generated by the rendering command, the command processing unit 120 generates a virtual rendering object for the actual rendering object and records the correspondence relationship between the virtual rendering object and the actual rendering object.

The display unit 110 of the client apparatus 100 displays processing results of the command processing unit 120 through the screen. Therefore, the output screen of the application program 150 of the server apparatus 140 is output through the display unit 110 of the client apparatus 100.

Although not illustrated, the client apparatus 100 may further include an input unit (for example, keyboard or mouse) that receives user inputs. When the user command is input to the client apparatus 100 through the user input unit, the corresponding command is sent to the server apparatus 140 through the data sending and receiving unit 130. In some cases, operations to be processed by the server apparatus 140 may be occurred while the client apparatus 100 processes commands received from the server apparatus 140. In this case, the corresponding command is also sent to the server apparatus 140 through the data sending and receiving unit 130.

In the exemplary embodiment of the present invention, a basic unit of a command that is sent and received between the server apparatus 140 and the client apparatus 100 is API. For example, the rendering command corresponds to the graphic rendering related API. As described above, a certain command is sent from the server apparatus 140 to the client apparatus 100 and is processed or is sent from the client apparatus 100 to the server 140 and is processed. If necessary, the processing result is returned. The command that is sent and received between the server apparatus 140 and the client apparatus 100 may be sent in one message type within a possible range.

Since both the virtual rendering objects and the actual rendering objects that are managed by the server apparatus 140 and the client apparatus 100 are substantially present on the memory, overhead may occur at the time of searching objects in the case of mapping the actual values of the objects for mapping the virtual rendering objects to actual rendering objects. Therefore, in the exemplary embodiment of the present invention, for solving the problem and the effective mapping between the objects, the objects are converted into codes that can be sent and received between the server apparatus 140 and the client apparatus 100 so that the objects of the opponent can be easily searched using the codes.

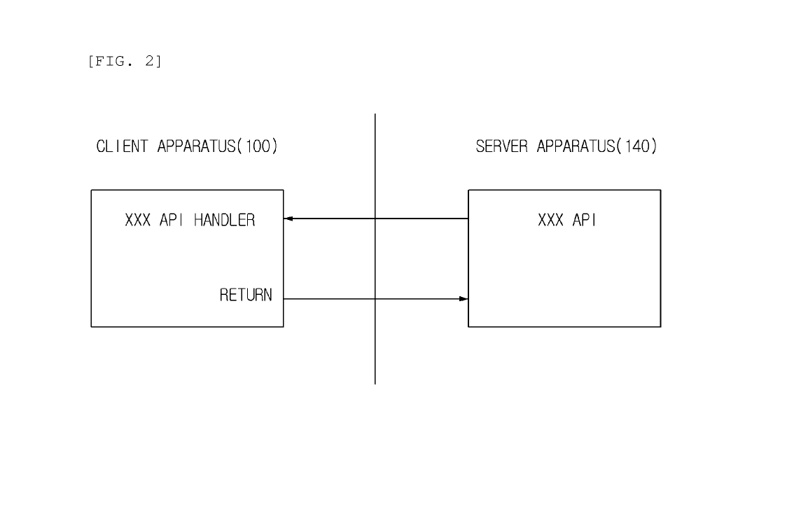

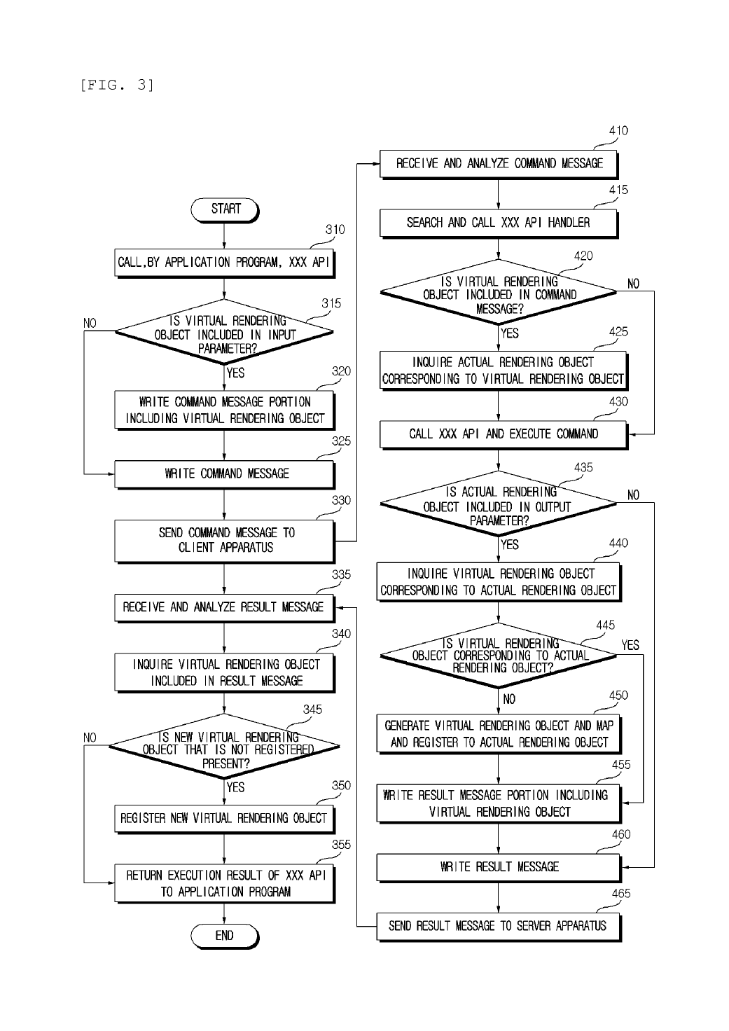

FIG. 2 is a conceptual diagram illustrating a command processing method of the server apparatus 140 and the client apparatus 100 in the foregoing application service providing system and FIG. 3 is a flow chart of an application service providing method corresponding to FIG. 2.

Referring to FIG. 2, the commands processed by the exemplary embodiment of the present invention are the rendering commands, which correspond to the XXX API that is the graphic API. For the application service, the XXX API that corresponds to the XXX API provided originally by the operation system is included in the server apparatus 140 and an XXX API handler for processing the XXX API is included in the client apparatus 100.

Referring to FIG. 3, steps 310 to 355 correspond to steps processed by the server apparatus 140 and steps 410 to 465 correspond to steps processed by the client apparatus 100.

The application program 150 calls the XXX API as needed during the execution or in response to the user command from the client apparatus 100 (S310).

When the virtual rendering objects are included in the input parameter of the XXX API (S315), the virtual rendering object management unit 170 inquires the virtual rendering objects and writes a command message portion including the virtual rendering objects (S320). For example, when the XXX API is the API that moves the window, the virtual rendering object management unit 170 inquires the corresponding virtual window object in the memory and writes the command message portion including the virtual window object. Then the virtual rendering object management unit 170 writes the overall command message (S325). When the virtual rendering objects are not included in the input parameters of the XXX API (S315), the virtual rendering object management unit 170 writes the command messages without passing through S320 (S325).

The virtual rendering object management unit 170 sends the command message to the data sending and receiving unit 180 and the data sending and receiving unit 180 sends the command message to the client apparatus 100 (S330).

The data sending and receiving unit 130 of the client apparatus 100 receives the command message from the server apparatus 140 and the command processing unit 120 analyzes the received command message (S410).

The command processing unit 120 searches the XXX API handler for processing the XXX API and calls the XXX API (S415). The command processing unit 120 inquires the actual rendering objects corresponding to the virtual rendering objects (S425) when the virtual rendering objects are included in the command message (S420). For example, when the received command is the window moving command, the actual window objects corresponding to the virtual window objects are previously generated, such that the command processing unit 120 inquires the actual window objects corresponding to the virtual window objects in the memory.

The command processing unit 120 uses the XXX API handler to call the XXX API and executes the command for the actual rendering objects (S430). When the virtual rendering objects are not included in the command messages (S420), the command processing unit 120 does not pass through S425 and calls the XXX API using the XXX API handler and executes the commands (S430). For example, when the received command is the window generation command, the command processing unit 120 generates the actual window object and displays the window through the display unit 110. For another example, when the received command is the window moving command, the command processing unit 120 moves the corresponding window displayed on the display unit 110 and changes position value of the actual window object for the corresponding window.

When the actual rendering objects are included in output parameters of the XXX API, the command processing unit 120 inquires the virtual rendering objects corresponding to the actual rendering objects (S440). When the virtual rendering objects corresponding to the actual rendering objects are present (S445), the command processing unit 120 writes the result message portion including the virtual rendering objects (S455). When the virtual rendering objects corresponding to the actual rendering objects are not present (S445), that is, when new rendering objects are generated by the execution of the XXX API, the command processing unit 120 generates the virtual rendering objects corresponding to the actual rendering objects and maps and registers the virtual rendering objects to the actual rendering objects (S450). The command processing unit 120 writes the result message portion including the generated virtual rendering objects (S455). Then the command processing unit 120 writes the overall result message (S460).

When the actual rendering objects are not included in the output parameters of the XXX API (S435), the command processing unit 120 writes the result message without passing through S440 to S455 (S460).

The command processing unit 120 sends the result message to the data sending and receiving unit 130 and the data sending and receiving unit 130 sends the result message to the server apparatus 140 (S465). However, this return is performed when there is a need to return the execution result to the server apparatus 140 depending on the command and otherwise, may be omitted.

The data sending and receiving unit 180 of the server apparatus 140 receives the result message from the client apparatus 100 and the virtual rendering object management unit 170 analyzes the received result message (S335). The virtual rendering object management unit 170 inquires the virtual rendering objects included in the result message (S340). If there is a new virtual rendering object which is not registered in the server apparatus 140 among the virtual rendering objects included in the result message (S345), the virtual rendering object management unit 170 registers the new virtual rendering object in the server apparatus (S350). Then the virtual rendering object management unit 170 returns the execution result of the XXX API to the application program 150 (S355).

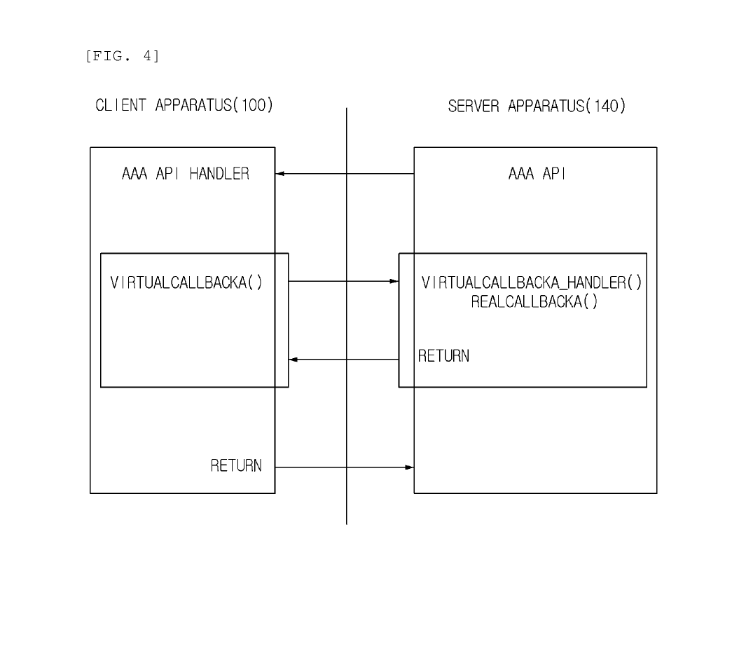

FIG. 4 is a conceptual diagram illustrating another command processing method of the server apparatus 140 and the client apparatus in the foregoing application service providing system. FIG. 4 illustrates the command processing method in case that the graphic related API corresponding to the rendering command includes a callback function. As known, the callback function is a function to process a certain event if the event occurs and has been written by an application program developer.

Generally, since the callback function is registered in the server, the callback function cannot be processed immediately by the client and is sent to the server and processed in the server even though the callback function occurs in the client. However, if the callback function is registered as a function to be processed by the client, the callback function may be processed by the client.

It is assumed that there is an application in which the callback function RealCallBackA( ) needs to be processed if a certain event occurs during the processing AAA API which is the graphic related API. Referring to FIG. 4, the AAA API corresponding to the AAA API provided originally by the operating system for the application service and the callback function RealCallBackA( ) included in the AAA API are prepared in the server apparatus 140. In connection therewith, the AAA API handler for processing the AAA API and the virtual callback function VirtualCallBackA( ) corresponding to the callback function RealCallBackA( ) are prepared in the client apparatus 100. Meanwhile, VirtualCallBackA_Handler( ) which is a handler for processing the VirtualCallBackA( ) is prepared in the server apparatus 140.

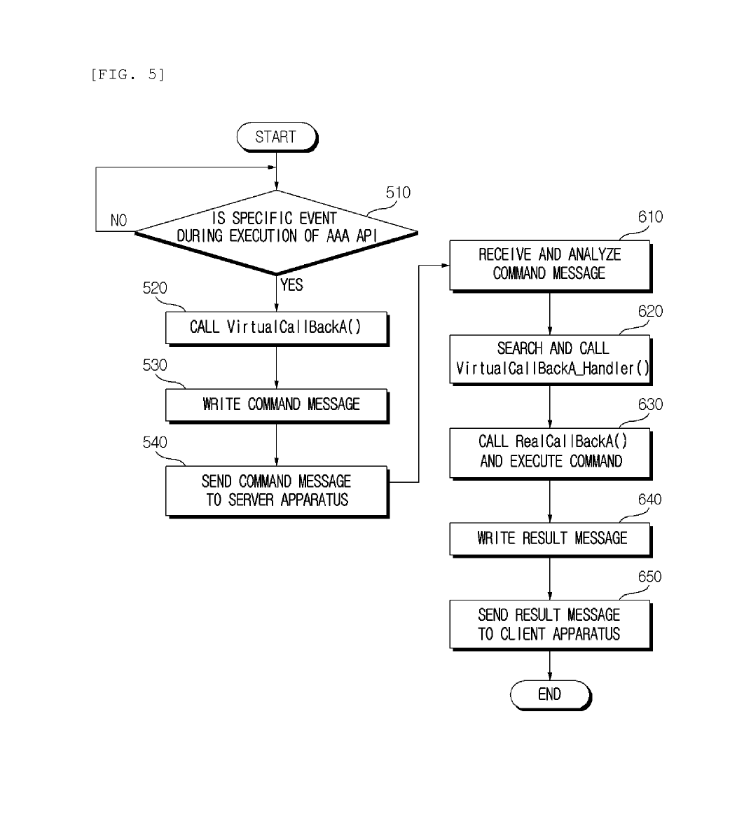

FIG. 5 is a flow chart illustrating a method for processing the call back function in the application service providing method illustrated in FIG. 4. Referring to FIG. 5, steps 510 to 540 correspond to steps processed by the client apparatus 100 and steps 610 to 650 correspond to steps processed by the server apparatus 100.

When a certain event occurs during the execution of the AAA API (S510), the client apparatus 140 calls VirtualCallBackA( ) (S520).

The client apparatus 140 writes the command message (S530). The step of writing the command message may include the same steps as S315 to S325 of FIG. 3.

The client apparatus 140 sends the command message to the server apparatus 140 (S540).

The server apparatus 140 receives the command message from the client apparatus 100 and analyzes the received command message (S610).

The server apparatus 140 calls VirtualCallBackA_Handler( ) for processing the VirtualCallBackA( ) according to the analysis of the command message (S620).

The server apparatus 140 uses the VirtualCallBackA_Handler( ) to call RealCallBackA( ) and execute the command (S620). The step of the RealCallBackA( ) call and the command execution may include the same steps as S420 to S430 of FIG. 3.

As the result of the command execution, the server apparatus 140 writes the result message (S630). The step of writing the result message may include the same steps as S435 to S460 of FIG. 3.

The server apparatus 140 sends the result message to the client apparatus 100 (S465). However, this return is performed when there is a need to return the execution result to the client apparatus 100 depending on the callback function and otherwise, may be omitted.

A new callback function or function call may be occurred during the client apparatus 100 or the server apparatus 140 processes a general function or a callback function. In this case, the new callback function or the function call is first processed as illustrated in FIGS. 5 and 3. That is, all the function calls are overlappingly processed.

According to the foregoing exemplary embodiments of the present invention, when the application program frequently uses the graphics processing unit (GPU) for performing 3D rendering, and the like, the rendering is performed by the graphic apparatus of the client and therefore, application services may be provided to a large number of clients with faster performance than the general server-based computing. Also, since both 2D rendering and 3D rendering are processed by the client, natural synchronization between a 2D graphic and a 3D graphic is achieved.

Unlike a method in which an output screen images are sent to a client whenever the output screen of the application program is updated, since the rendering command with smaller amount than the image is sent to the client, the graphic apparatus of the client may be maximally used and the server load is relieved such that the service with the improved performance may be provided to a larger number of clients.

Also, by generating and managing the virtual window objects in the server separately from the window system, the windows of the application programs can be managed independently from and without depending on the window manager of the operating system of the server. Therefore, the effects between windows each other happened at the time of window operation are minimized, such that two or more users may simultaneously execute smoothly the plurality of application programs under the same desktop environment of the same server.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An application service providing system, comprising:
a server apparatus that generates information for screen output of application program as virtual rendering objects and sends commands using the virtual rendering objects as parameters to a client apparatus; and
a client apparatus that receives the commands, generates actual rendering objects corresponding to the virtual rendering objects, and uses the actual rendering objects to execute the commands.

2. The application service providing system of claim 1, wherein the commands include a rendering command.

3. The application service providing system of claim 1, wherein the information for the screen output includes window information.

4. The application service providing system of claim 3, wherein the virtual rendering objects include a virtual window object.

5. The application service providing system of claim 4, wherein the server apparatus manages the virtual window object independently from a window manager of an operating system of the server apparatus.

6. A server apparatus for an application service, comprising:
a virtual rendering object management unit that generates information for screen output of application program as virtual rendering objects and generates commands using the virtual rendering objects as parameters; and
a data sending and receiving unit that sends the commands to a client apparatus.

7. The server apparatus of claim 6, wherein the commands include a rendering command.

8. The server apparatus of claim 6, wherein the information for the screen output includes window information.

9. The server apparatus of claim 8, wherein the virtual rendering objects include a virtual window object.

10. The server apparatus of claim 9, wherein the virtual rendering object management unit manages the virtual window object independently from a window manager of an operating system of the server apparatus.

11. A client apparatus for an application service, comprising:
a data sending and receiving unit that generates information for screen output of application program as virtual rendering objects and receives commands using the virtual rendering objects as parameters; and
a command processing unit that generates actual rendering objects corresponding to the virtual rendering objects and executes the commands on the actual rendering objects.

12. The client apparatus of claim 11, wherein the commands include a rendering command.

13. The client apparatus of claim 11, wherein the information for the screen output includes window information.

14. The client apparatus of claim 13, wherein the virtual rendering objects include a virtual window object.

15. A method for providing an application service, comprising:
calling, by application program included in a server, graphic rendering related API;
generating rendering objects required in the graphic rendering related API as virtual rendering objects; and
sending rendering commands using the generated virtual rendering objects as parameters to a client.

16. The method of claim 15, wherein the virtual rendering objects include a virtual window object.

17. The method of claim 15, further comprising:
receiving, by the client, the command; and
generating actual rendering objects corresponding to the virtual rendering objects to execute the command.

18. The method of claim 17, further comprising:
calling a virtual callback function during the execution of the command;
sending the command corresponding to the virtual callback function to the server; and
calling, by the server, an actual callback function corresponding to the virtual callback function to execute the command.
